(19) United States
(12) Patent Application Publication
(10) Pub. No.: US 2010/0294525 A1
(43) Pub. Date: Nov. 25, 2010

(54) HAND TOOL MACHINE

(75) Inventors: Gerhard Meixner, Filderstadt (DE); Thomas Bernhardt, Aichtal-Groetzingen (DE); Andreas Strasser, Rudersberg (DE); Tobias Herr, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(73) Assignee: Sony France S.A., Clichy La Garenne (FR)

(21) Appl. No.: 12/681,855

(22) PCT Filed: Sep. 2, 2008
(86) PCT No.: PCT/EP2008/061517

§ 371 Date: Jun. 22, 2010

(30) Foreign Application Priority Data
Oct. 8, 2007 (DE) 102007048262.2

(51) Int. Cl. B25D 17/24

(52) U.S. Cl. 173/210

(57) ABSTRACT

The invention relates to a hand tool machine, particularly a drill and/or chisel hammer, having a striking unit comprising at least one hammer and one striking element, and having a damping device for the striking element for damping a B-strike of the striking element against a striking unit. The invention proposes that the damping device have at least one axial overlap region with the hammer in at least one operating mode.

### PRIOR ART

The invention is based on a hand-held power tool with the defining characteristics of the preamble to claim 1.

There are already known hand-held power tools, in particular rotary hammers and chisel hammers, that have an impact mechanism unit with a striking element, an impact means, and a damping device for the impact means in order to damp a B-impact of the impact means.

### ADVANTAGES OF THE INVENTION

The invention is based on a hand-held power tool, in particular a rotary hammer and/or chisel hammer, having an impact mechanism unit, which is equipped with at least one striking element and an impact means, and having a damping device for the impact means in order to damp a B-impact of the impact means.

According to one proposal, in at least one operating mode, the damping device has at least one axial overlap region with the striking element. An “impact mechanism unit” should be understood here in particular to be a unit that has at least one component such as an impact means, a hammer tube, a pot piston, and/or a striking element and that is involved in the production and/or transmission of an impulse to a tool. In this context, the term “damping device” in particular defines a device that reduces a striking impulse, preferably of an impact means, by more than 10%, preferably by more than 50%, and ideally, by more than 90%. The damping device can be composed of a plurality of elements with different damping properties. The “impact means” is preferably an impact pin or impact die and is preferably an element that is separate from the striking element. The impact means could, however, also be a striking element. A “B-impact” should be understood here in particular to be an impact, preferably an impact that is experienced by the impact means and is oriented in the direction opposite from the impact of the impact means on a tool shaft. In this case, the B-impact is constituted by an impulse in the form of a reverse impulse from the tool shaft to the impact means that occurs after a striking motion directed from the impact means to the tool shaft. The term “operating mode” in this context defines in particular an arrangement of the components of the impact mechanism unit and/or of a tool that determines a possible function such as a drilling, chiseling, and/or idle mode of the hand-held power tool. An “overlap region” should in particular be understood here to mean a region in which the damping device and the striking element overlap or cover each other in the axial direction, i.e. in which there is at least one plane oriented perpendicular to the axial direction that extends through both the striking element and the damping device. Preferably, the damping device and the striking element are arranged at least partially parallel to each other, viewed in the axial direction. Through the implementation of the overlap region, it is advantageously possible to achieve a reduction in the length of the impact means as compared to a conventional design. A length of the impact mechanism unit is therefore independent of a length of the damping device. Moreover, savings can be achieved in terms of material, available space, and costs.

According to another proposal, the operating mode is an idle setting. An “idle setting” should in particular be understood here to mean an operating mode of the hand-held power tool in which at least one motor of the hand-held power tool is operating, but in which in particular, the tool is not experiencing any striking impulses, particularly because the tool is still situated outside of an impact position. Consequently, the motor and the tool are decoupled. Through a corresponding embodiment, it is possible in a simply designed fashion to achieve both a compact design and an advantageous guidance of the striking element in a working mode.

The damping device advantageously has at least one damping element with an extension region that has at least one inner diameter that is at least equal in size to an inner diameter of a hammer tube. An “extension region” should be understood here in particular to be at least a subregion of the damping element that extends in the axial direction of the hand-held power tool and/or has an axial length that is at least 10% of that of the damping element. Through the implementation of the reciprocally matched inner diameter of the extension region of the damping element and of the hammer tube, it is possible to achieve a space-saving idle setting of the hand-held power tool in a simply designed fashion. In addition, it is possible to reliably avoid a possible damage to the damping element resulting from a possible impact of the striking element in the impact position.

Preferably, the damping element is composed of a spring-elastic element such as an elastomer, a helical spring, and/or another spring-elastic element deemed suitable for the purpose by a person skilled in the art. The expression “spring-elastic element” should be understood here in particular to mean an element that absorbs energy and then releases it again by means of a reversible deformation; the deformation is preferably greater than 2% of a longitudinal span of the damping element. The embodiment according to the invention can be used to produce an inexpensive damping element in a simply designed fashion.

It is also advantageous if the damping element is embodied in the form of a ring, permitting the B-impact to be damped in a simply designed fashion.

A preferred modification is comprised in the fact that the extension region is situated on a side of the striking element oriented toward a tool holder in the axial direction. It is thus possible to have the extension region of the damping element straddle the striking element in a particularly space-saving manner.

It can also be advantageous for the hammer tube to have a recess in which the damping device is at least partially situated. The recess in this case preferably accommodates at least most of at least one damping element of the damping device, preferably in its axial length and/or radial depth, and/or at least 50% of the volume of the damping element is accommodated in the recess. In addition, the recess advantageously extends in a circumference direction completely around an impact mechanism component such as the striking element.

Another embodiment of the invention includes a transmitting element, which is provided to at least partially transmit the B-impact from the impact means to the damping element. A “transmitting element” should be understood here in particular to mean an element that is specifically provided to transmit an impulse to the damping element. In this case, the transmitting element can be composed of a damping element itself or an element that is essentially immobile in relation to the damping element. This stops the impact means before it reaches the striking element in its movement and the B-impact is transmitted to the damping element of the damping device.

According to another proposal, the transmitting element is situated on a side of the damping element remote from the striking element in the axial direction, permitting the impulse to be transmitted in a simply designed fashion.

Preferably, the transmitting element is composed of a support ring and/or a support washer. This makes it possible to achieve a space-saving and/or reasonably priced design.

According to another proposal, the impact mechanism unit has a tubular component that is provided to guide the striking element in the overlap region. A “tubular component” should be understood here in particular to mean an element that is situated and/or guided in a hammer tube; the hammer tube is provided to guide the element along an impact direction during operation of the hand-held power tool. In addition, the element contains at least one impact means, preferably a striking element, that is supported so that it is able to move in the striking direction. The arrangement of the tubular component makes it possible to achieve an improved guidance of the striking element. In addition, the length of the recess for the damping element can be embodied independently of a required sliding surface of the striking element, particularly in an impact mode of the hand-held power tool. In addition, the tubular component can be a pot piston, making it possible to achieve a flexible embodiment of the impact mechanism.

A preferred modification is comprised in the fact that a damping element is at least partially situated radially outside the pot piston. It is thus possible to achieve a wearless support of the damping element and a variable damping in a simply designed way.

### DRAWINGS

Other advantages ensue from the following description of the drawings. The drawings show exemplary embodiments of the invention. The drawings, the description, and the claims contain numerous features in combination. The person skilled in the art will also suitably consider the features individually and unite them in other meaningful combinations.

FIG. 1 shows a hand-held power tool equipped with an impact mechanism unit according to the invention,

FIG. 2a is a sectional view of the impact mechanism unit with a damping device in a working position,

FIG. 2b is a sectional view of the impact mechanism unit with a damping device in an idle setting,

FIG. 3 is a section along line III-III through the impact mechanism unit and damping device shown in FIG. 2b,

FIG. 4a is a sectional view of the impact mechanism unit with an alternative damping device in a working position, and

FIG. 4b is a sectional view of the impact mechanism unit with an alternative damping device in an idle setting.

### DESCRIPTION OF THE EXEMPLARY EMBODIMENTS

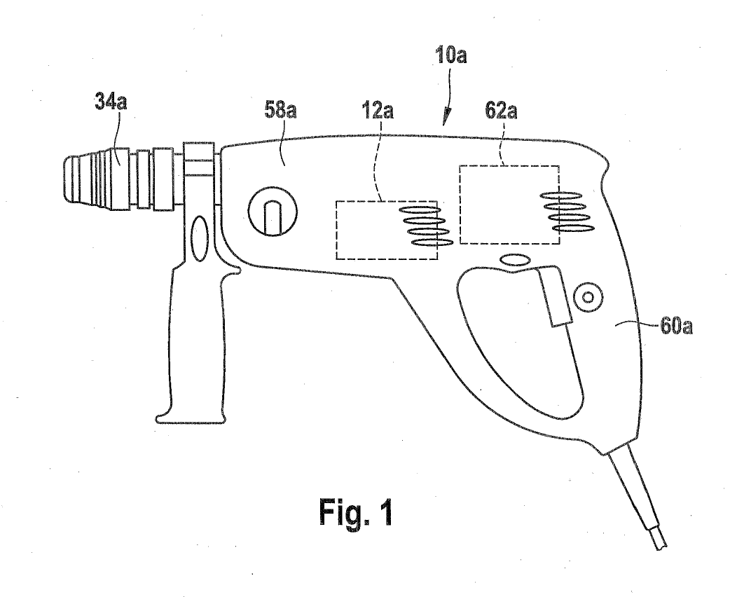

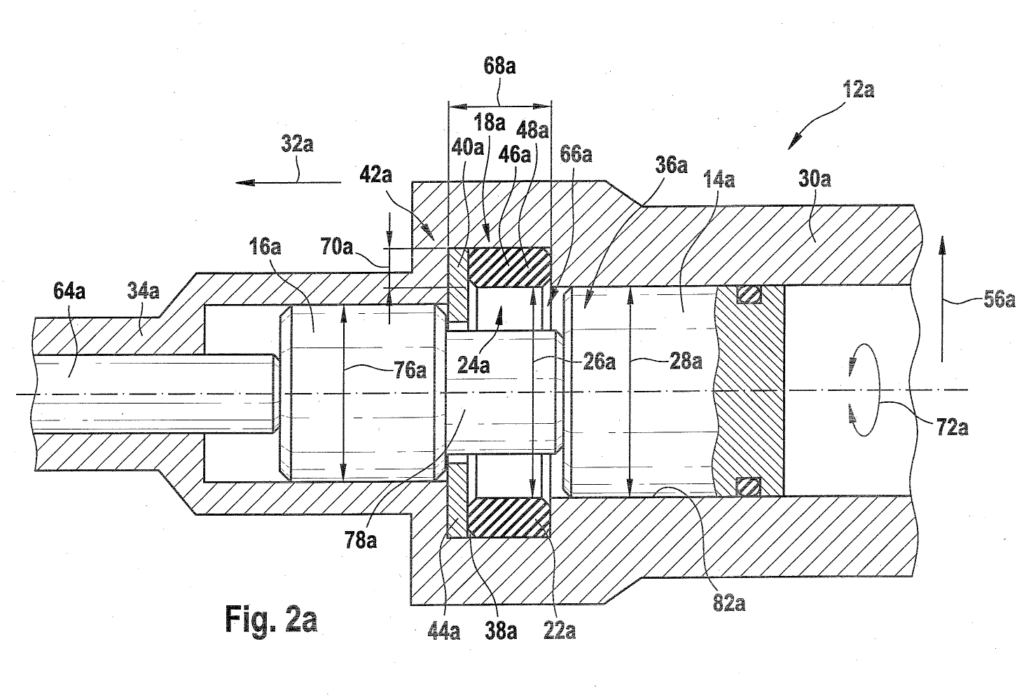

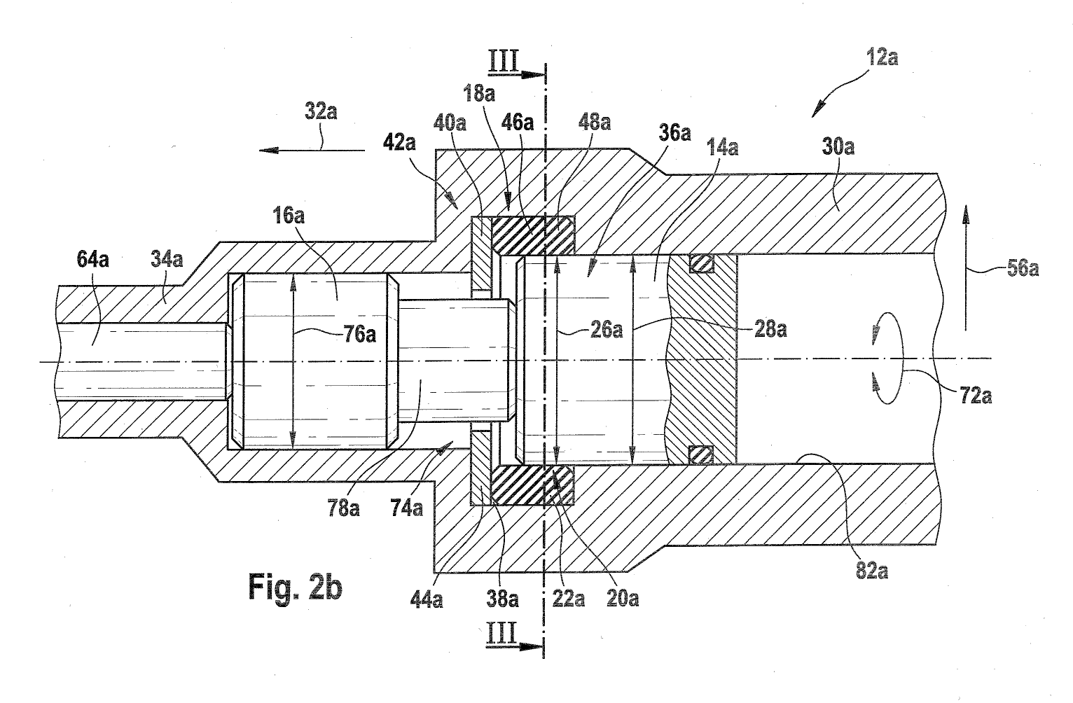

FIG. 1 shows a hand-held power tool 10a according to the invention embodied in the form of a rotary hammer, having a housing 58a, a main handle 60a, and a motor unit 62a. The housing 58a also contains an impact mechanism unit 12a that has a hammer tube 30a, a striking element 14a, and an impact means 16a in the form of an impact pin (see FIGS. 2a and 2b). The striking element 14a and the impact means 16a are guided in moving fashion in the hammer tube 30a and the impact means 16a is situated after the striking element 14a in the axial direction 32a toward a tool holder 34a. An impulse transmission of an impact passes from the motor unit 62a via the striking element 14a to the impact means 16a and from the impact means 16a to a tool shaft of a tool 64a. In an impact mode (see FIG. 2a), after the impulse transmission of the impact, the impact means 16a experiences a so-called B-impact, i.e. an impact oriented in the opposite direction from the impact that the impact means 16a imparts to the tool shaft of the tool 64a. This produces a reverse impulse from the tool shaft of the tool 65a to the impact means 16a. In an impulse transmitting region 66a situated between the striking element 14a and the impact means 16a, a damping device 18a for the impact means 16a is provided to damp the B-impact of the impact means 16a.

The damping device 18a includes a damping element 22a and a transmitting element 40a and in at least one operating mode, in particular the idle setting (see FIG. 2b), has an axial overlap region 20a with the striking element 14a. In this case, the striking element 14a and the damping device 18a, with its overlap region 20a or more precisely, the damping element 22a are arranged parallel to each other, viewed in the axial direction 32a toward the tool holder 34a. In the idle setting of the hand-held power tool 10a, the overlap region 20a includes at least 90% of the damping device 18a and in its movement in the idle setting, the striking element 14a travels past at least 95% of the damping element 22a along the axial direction 32a.

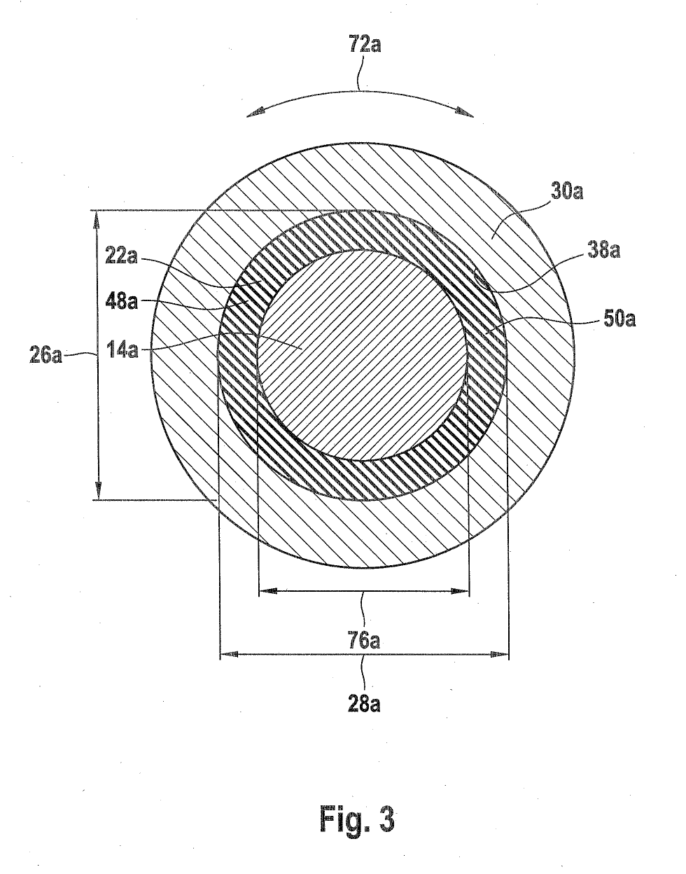

In order to implement the overlap region 20a, the damping device 18a or more precisely stated, the damping element 22a, has an extension region 24a that has an inner diameter 26a that is equal in size to an inner diameter 28a of the hammer tube 30a. The extension region 24a is situated in the axial direction 32a on a side 36a of the striking element 14a that is oriented toward the tool holder 34a. The hammer tube 30a also contains a recess 38a in which the damping device 18a is situated. The recess 38a has an axial length 68a that corresponds to the length of the damping device 18a. The recess 38a also has the same radial depth 70a as the damping element 22a. In addition, the recess 38a extends all the way around the striking element 14a (see FIG. 3) in the circumference direction 72a. The damping element 22a is composed of a spring-elastic element 46a that is composed of an elastomer 48a embodied in the form of a ring 50a situated in the recess 38a.

The transmitting element 40a of the damping device 18a, which is provided to at least partially transmit the B-impact from the impact means 16a to the damping element 22a, is situated in the axial direction 32a on a side 42a of the damping element 22a remote from the striking element 14a and is embodied in the form of a support washer 44a. In this case, the transmitting element 40a protrudes from the hammer tube 30a toward the striking element 14a in a direction opposite from the radial direction 56a, into a movement chamber 74a of the impact means 16a and limits a movement of the impact means 16a, which is caused by the B-impact, in the direction opposite from the axial direction 32a. In order to bridge across the narrowed movement chamber 74a and to achieve an efficient impulse transmission of the impact impulse from the striking element 14a to the impact means 16a, the impact means 16a has a region 78a with a reduced diameter 76a.

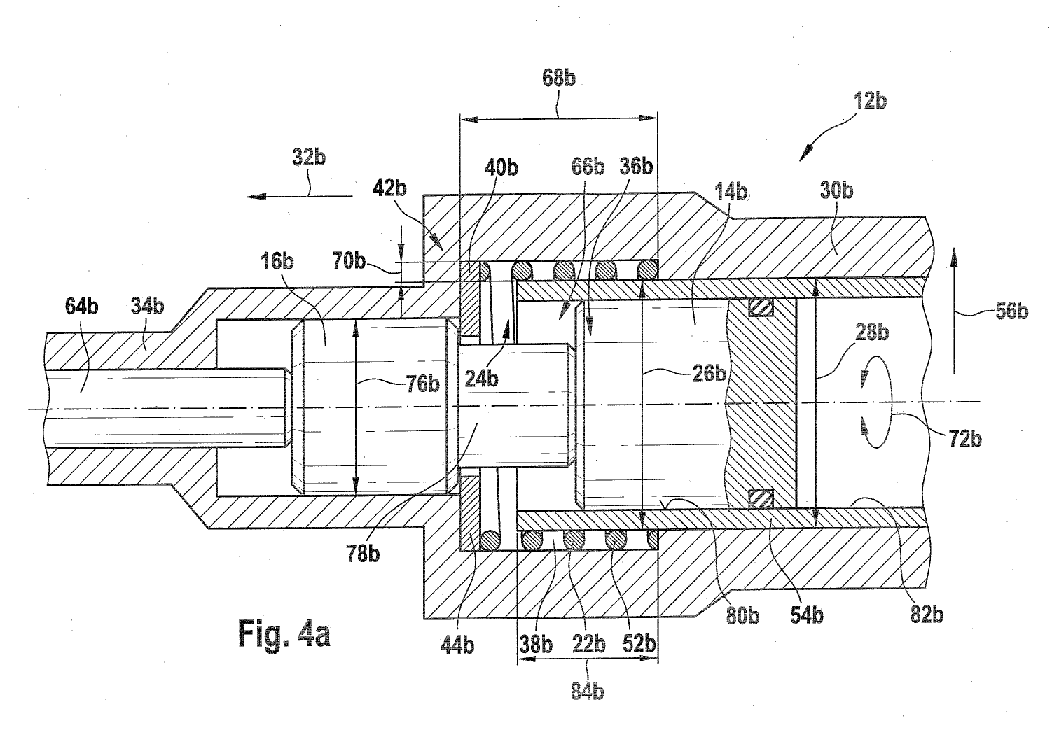

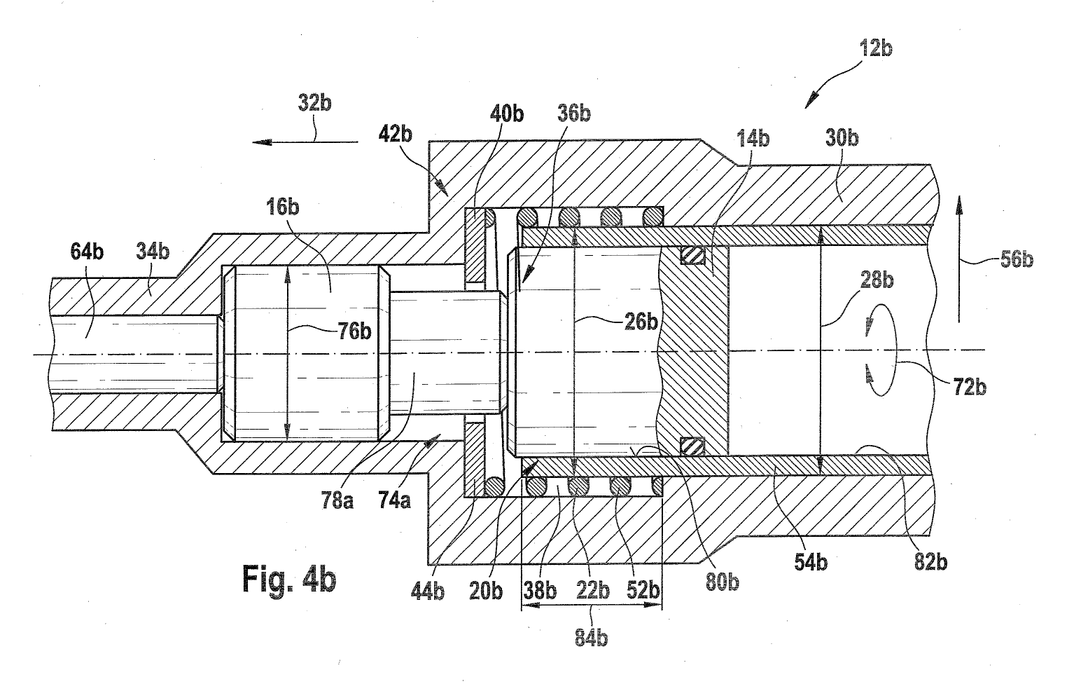

FIGS. 4a and 4b show an alternative exemplary embodiment of the hand-held power tool 10a and the impact mechanism unit 12a. Components, features, and functions that remain the same have essentially been provided with the same reference numerals. In order to differentiate between the exemplary embodiments, however, the letters a and b have been added to the reference numerals of the different exemplary embodiments. The description below is limited essentially to the differences from the exemplary embodiment shown in FIGS. 2a and 2b; for components, features, and functions that remain the same, the reader can refer to the description of the exemplary embodiment shown in FIGS. 2a and 2b.

FIGS. 4a and 4b show an impact mechanism unit 12b with a striking element 14b, an impact means 16b, and a damping device 18b for the impact means 16b; the damping device 18b is provided for damping a B-impact of the impact means 16b. The damping device 18b is composed of a damping element 22b and a transmitting element 40b and in at least one operating mode, namely an idle setting (see FIG. 4b), has an axial overlap region 20b with the striking element 14b.

The damping element 22b is composed of a helical spring 52b that is situated in a recess 38b and encompasses the striking element 14b in the circumference direction 72b. In addition, the impact mechanism unit 12b has a tubular component 54b that is provided to guide the striking element 14b in an overlap region 20b. In order to achieve optimum sliding properties of the striking element 14b in an impact position of the impact mechanism unit 12b (see FIG. 4a), the tubular complement 54b provides a sliding surface 80b that serves to elongate the guidance region 82b by a length 84b. The damp the element 22b, i.e. the steel helical spring 52b, is situated outside of the tubular component 54b in the radial direction 56b, viewed from the striking element 14b in the direction toward the hammer tube 30b and encompasses the tubular component 54b in the circumference direction 72b.

1-14. (canceled)

15. A hand-held power tool, in particular a rotary hammer and/or chisel hammer, comprising:
an impact mechanism unit equipped with at least one striking element and an impact means; and
a damping device for the impact means which damps a B-impact of the impact means, and in at least one operating mode, the damping device has at least one axial overlap region with the striking element.

16. The hand-held power tool as recited in claim 15, wherein the operating mode is an idle setting.

17. The hand-held power tool as recited in claim 15, wherein the damping device has at least one damping element with an extension region that has at least one inner diameter that is at least equal in size to an inner diameter of the hammer tube.

18. The hand-held power tool as recited in claim 16, wherein the damping device has at least one damping element with an extension region that has at least one inner diameter that is at least equal in size to an inner diameter of the hammer tube.

19. The hand-held power tool as recited in claim 17, wherein the extension region is situated on a side of the striking element oriented toward a tool holder in an axial direction.

20. The hand-held power tool as recited in claim 18, wherein the extension region is situated on a side of the striking element oriented toward a tool holder in an axial direction.

21. The hand-held power tool as recited in claim 17, wherein the hammer tube has a recess in which the damping device is at least partially situated.

22. The hand-held power tool as recited in claim 18, wherein the hammer tube has a recess in which the damping device is at least partially situated.

23. The hand-held power tool as recited in claim 17, wherein a transmitting element is provided for at least partially transmitting the B-impact from the impact means to the damping element.

24. The hand-held power tool as recited in claim 18, wherein a transmitting element is provided for at least partially transmitting the B-impact from the impact means to the damping element.

25. The hand-held power tool as recited in claim 23, wherein the transmitting element is situated on a side of the damping element oriented away from the striking element in an axial direction.

26. The hand-held power tool as recited in claim 23, wherein the transmitting element is composed of a support washer.

27. The hand-held power tool as recited in claim 17, wherein the damping element is composed at least partially of a spring-elastic element.

28. The hand-held power tool as recited in claim 18, wherein the damping element is composed at least partially of a spring-elastic element.

29. The hand-held power tool as recited in claim 27, wherein the damping element is composed of an elastomer.

30. The hand-held power tool as recited in claim 17, wherein the damping element is embodied in the form of a ring.

31. The hand-held power tool as recited in claim 18, wherein the damping element is embodied in the form of a ring.

32. The hand-held power tool as recited in claim 27, wherein the damping element is composed of a helical spring.

33. The hand-held power tool as recited in claim 15, wherein the impact mechanism unit has a tubular component that is provided for guiding the striking element in the overlap region.

34. The hand-held power tool as recited in claim 33, wherein a damping element is at least partially situated outside the tubular component in the radial direction.
